(19) United States
(12) Patent Application Publication
(10) Pub. No.: US 2013/0063679 A1
(43) Pub. Date: Mar. 14, 2013

(54) Backlight Module and Liquid Crystal Display Device Using the Same

(71) Applicant: Guofu Tang, Shenzhen (CN)

(72) Inventor: Guofu Tang, Shenzhen (CN)

(21) Appl. No.: 13/375,569

(22) PCT Filed: Sep. 24, 2011
(86) PCT No.: PCT/CN2011/080141

§ 371 Date: Dec. 1, 2011

(30) Foreign Application Priority Data
Sep. 8, 2011 (CN) 201120336931.0

(51) Int. Cl. G02F 1/1335; G09F 13/04

(52) U.S. Cl. 349/61; 362/602

(57) ABSTRACT

The present invention discloses a backlight module and a liquid crystal display (LCD) device using the same. Said backlight module comprises a light emitting diode (LED) light cluster composed of a group of LEDs, and a light guide plate (LGP) which is arranged on the side of said LED light cluster and is coupled with the LED; wherein said backlight module also comprises a limit structure for making the position between said LGP and said LED light cluster be relatively fixed. Because the present invention uses a limit structure for making the position between the edge of said LGP and said LED light cluster be relatively fixed, the limit structure limits the edge position of the LGP; when the tolerance of the LGP is upwards and downwards offset, adjustment can be performed by the limit structure and the edge of the LGP. Meanwhile, the local displacement when the LGP expends with heat can be prevented from occurring. Thus, the coupling efficiency of the LGP and the LED light cluster is increased.

### TECHNICAL FIELD

The present invention relates to the field of liquid crystal display devices (LCDs), particularly to a backlight module and a LCD device using the same.

### BACKGROUND

The backlight module is one of the critical components of the LCD panel. Because the liquid crystal does not have the light emitting characteristic, alight emitting source must be added onto the bottom surface of the LCD panel to achieve the display effect of full color. The edge-lit LED backlight module usually comprises a light emitting diode (LED) light cluster composed of a group of LEDs, and a light guide plate (LGP) which is arranged on the LED side of the LED light cluster and is coupled with the LEDs; the LED beams are dispersed into the planar light sources which can supply adequate brightness and are uniformly distributed by the light guide plate so that the LCD can normally display images.

At present, the thickness of the edge-lit LED backlight module is thinner and thinner; the LED tends to be miniaturized, and the LGP tends to be thinned. Consequently, the emergent-light surface of the LED can not be aligned with the incident-light surface of the LGP because of tolerance, thermal expansion, warpage and the like in the process of production and assembly. Thus, the coupling efficiency of the LED and the LGP is reduced. FIG. 1 and FIG. 2 show the existing edge-lit LED backlight module; the LGP 15 is compacted in the backlight cavity by the backplane 16 and the rubber frame (not shown in the Figure) and then is aligned with the LED 121; and the coupling efficiency is greatly affected by the aforementioned tolerance, thermal expansion, warpage and the like.

### SUMMARY

The aim of the present invention is to provide a backlight module and a LCD device using the same with higher coupling efficiency of LED and LGP.

The purpose of the present invention of the backlight module is achieved by the following technical schemes. A backlight module comprises a LED light cluster composed of a group of LEDs, and a light guide plate which is arranged on the LED side of the LED light cluster and is coupled with the LED, wherein said backlight module also comprises one or more limit structures for making the position between the edge of said LGP and said LED light cluster be relatively fixed.

Preferably, said limit structure is a projecting part which is fixed relatively to said LED and is extended to the LGP to limit the edge of the LGP. The edge of the LGP is limited by the projecting part so that the LGP is accurately positioned.

Preferably, said projecting part is of a wedge structure which is fixed relatively above or below to the LED and protrudes above the emergent-light surface of the LED; and the beveled surface of the wedge structure faces the LGP. When the tolerance of the LGP is upwards and downwards offset, the distance can be automatically and slightly adjusted by using the wedge structure and the edge of the LGP; when the LGP expands with heat, the LGP cannot touch the LED surface under the obstruction action of the beveled surface of the wedge structure; in addition, for the wedge structure arranged above the LED, the beveled surface of the wedge structure facing the LGP can reflect the light emitted by the LED into the LGP without adding additional reflection sheets.

Preferably, the position of the LGP corresponding to the wedge structure is provided with a chamfer structure corresponding to the beveled surface of said wedge structure. The LGP is provided with a chamfer corresponding to the wedge structure so that the coupling efficiency of the LGP and the LED becomes higher, and the adjustment becomes more accurate when the tolerance is upwards and downwards offset, and position of the LGP is more reliable under the cooperation of the wedge structure and the chamfer when the LGP expands with heat.

Preferably, the single LED of said LED light cluster is externally provided with independent packaging, and said limit structure is arranged on the independent packaging of the single LED of said LED light cluster. Because the limit structure is arranged on the packaging of the single LED, multiple limit structures can be correspondingly arranged as required.

Preferably, all the LEDs of said LED light cluster are externally provided with integral packaging, and said limit structure is arranged on the integral packaging of said LED light cluster. Because the limit structure is arranged on the integral packaging of said LED light cluster, manufacture and assembly become more convenient; and because the length of the limit structure is increased, the limitation of position becomes more reliable and accurate.

Preferably, said limit structure is arranged on the printed circuit board (PCB) fixed relatively to said LED light cluster. The limit structure can be an independent part and arranged on the PCB.

Preferably, said limit structure is a projecting part which is fixed relatively to the edge of the LGP and is extended to the fixed structure of the LED to limit the LGP. The limit structure can be arranged at the edge of the LGP, and the LGP is integrated with the limit structure.

Preferably, said limit structure is a lug boss which is fixed relatively to said LED light cluster or is arranged at the edge of said LGP; correspondingly, the edge of the LGP or the position fixed relatively to said LED light cluster is provided with a depression corresponding to said lug boss. The limit structure can be various, and the lug boss and the depression corresponding to the lug boss can achieve the function of limitation as well.

The purpose of the LCD device of the present invention is achieved by the following technical schemes. A LCD device comprises the aforementioned backlight module.

Because the present invention uses one or more limit structures for making the position between said LGP and said LED light cluster be relatively fixed in the backlight module, the limit structure limits the edge of the LGP and the LED light cluster; when the edge of the LGP is deformed and displaced because of tolerance, warpage and the like, the edge of the LGP can be limited by the limit structure. Meanwhile, when the LGP expands with heat, the local displacement can be prevented from occurring. Thus, the emergent-light surface of the LED can be preferably aligned with the incident-light surface of LGP, and then the coupling efficiency of the LGP and the LED light cluster is increased.

### BRIEF DESCRIPTION OF FIGURES

FIG. 1 is the schematic diagram of the existing backlight module (not showing all the components of the backlight module);

FIG. 2 is the three-dimensional simplified diagram of the backlight module of the prior art;

FIG. 3 is the schematic diagram of one embodiment of the present invention;

FIG. 4 is the three-dimensional simplified diagram of one embodiment of the present invention;

FIG. 5 is the simplified diagram of another embodiment of the present invention; and

FIG. 6 is the simplified diagram of a third embodiment of the present invention.

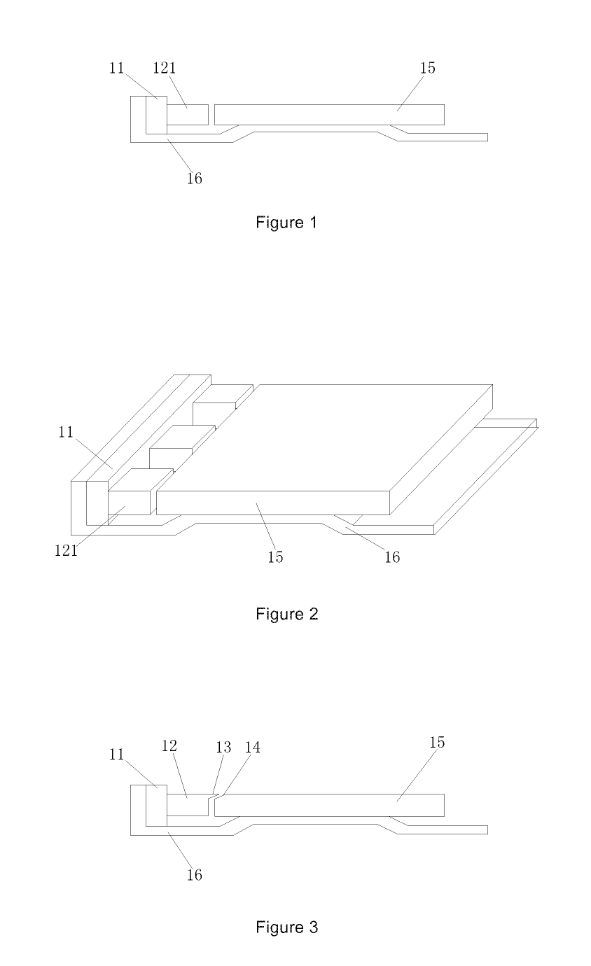

Wherein: 11. PCB; 12. LED light cluster; 121. LED; 122. packaging; 13. wedge structure; 14. chamfer; 15. LGP; 16. backplane.

### DETAILED DESCRIPTION

The present invention will further be described in detail in accordance with the figures and the preferred embodiments.

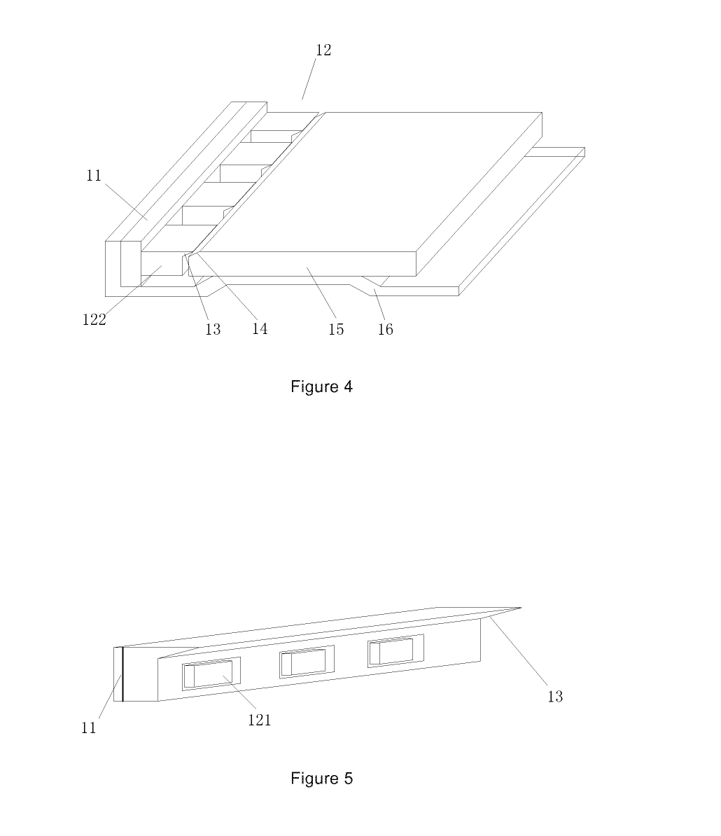

FIG. 3 and FIG. 4 show the coupling of the LED 121 of the LED light cluster 12 and the LGP 15 of a backlight module of the present invention. In the figures, the LGP 15 is positioned in the backlight cavity of the backlight module and is aligned with the LED 121 on the side of the LED light cluster 12; said LED light cluster 12 is arranged on the strip-shaped PCB 11; and the PCB 11 and the LGP 15 are supported in the backlight cavity through the backplane 16.

In the backlight module shown in FIG. 3 and FIG. 4, the upper end of the emergent-light surface of the LED light cluster 12 is provided with one or more wedge structures 13; the wedge structure 13 protrudes over the emergent-light surface of the LED light cluster 12; and the LGP 15 is provided with a chamfer 14 corresponding to the beveled surface of said wedge structure 13. The wedge structure 13 and the chamfer 14 mutually cooperate so that the edge of the LGP 15 is limited. Thus, the coupling efficiency of the LGP 15 and the LED light cluster 12 is increased, and the reliability of positioning of the LGP 15 is increased. When the tolerance of the LGP 15 is upwards and downwards offset, adjustment is performed by matching the wedge structure 13 with the chamfer 14 to accurately couple the LGP 15 with the LED light cluster 12. Meanwhile, when the LGP 15 is deformed and displaced after the LGP 15 expands with heat, the wedge structure 13 can prevent the outer edge of the LGP 15 from moving in the direction of the LED light cluster 12 and extruding the LED light cluster 12 because of expansion; and the wedge structure 13 can prevent the occurrence of local deformation and warpage of the LGP 15 affected by the heat, which can result in the reduction of the coupling efficiency. In addition, in order to increase the light utilization ratio, the reflection sheets are often pasted above the LED of the backlight module in the prior art, such as on the rubber frame; while in an embodiment, because the wedge structure 13 is arranged above the emergent-light surface of the LED light cluster 12, the wedge structure 13 can reflect the light of the LED light cluster 12 into the LGP. Thus, reflection sheets are not required to be additionally added, and the light utilization ratio of the LED light cluster 12 is increased.

In the embodiment, said wedge structure 13 is arranged on the independent packaging 122 of the single LED. Thus, the number of the wedge structure 13 can be set according to the actual situation; alternatively, because the wedge structure 13 can be arranged on the integral packaging of said LED light cluster 12 as well, manufacture and assembly become more convenient; and because the length of the limit structure is increased, the position limitation becomes more reliable and accurate; alternatively, because the wedge structure can be a single part additionally manufactured, the manufacture of the parts of all the sections becomes convenient. As shown in FIG. 5, the single wedge structure 13 can be arranged on the PCB 11 or other positions fixed relatively to the LED light cluster. In addition, the chamfer 14 arranged on the LGP 15 is corresponding to the beveled surface of the wedge structure 13, after the chamfer 14 is matched with the wedge structure 13; the coupling efficiency of the LGP 15 and the LED light cluster 12 becomes higher; the adjustment becomes more accurate when the tolerance is upwards and downwards offset; and the position of the LGP is more reliable under the cooperation of the wedge structure and the chamfer when the LGP is expends with heat. Of course, the purpose of the present invention can be completely achieved if the LGP 15 is not provided with the chamfer 14.

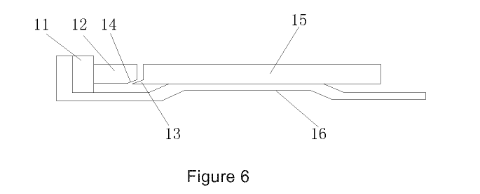

Of course, the wedge structure 13 can be arranged on the LGP 15. As shown in FIG. 6, the lower end of the incident-light surface of the LGP 15 is provided with a wedge structure 13, and the LED light cluster 12 is provided with a chamfer 14 corresponding to the wedge structure 13. Alternatively, both the upper end of the emergent-light surface of the LED light cluster 12 and the lower end of the incident-light surface of the LGP 15 are respectively provided with a wedge structure. Such design can improve the coupling efficiency of the LED light cluster 12 and the LGP 15 and do not require additional reflection sheets.

In the aforementioned embodiment, said wedge structure 13 is only a specific embodiment of the limit structure making the position between the edge of said LGP and said LED light cluster be fixed relatively; and the limit structure can be in other structural forms as well; for example, said limit structure is a lug boss which is fixed relatively to said LED light cluster or is arranged at the edge of said LGP; correspondingly, the position of the LGP edge or the position fixed relatively to said LED light cluster is provided with a depression corresponding to said lug boss, or through the forms of bending, etc. Each purpose is to provide a limit structure so that the edge of the LGP 15 is fixed relatively to the position of the LED light cluster 12. Thus, the coupling efficiency of the LGP 15 and the LED light cluster 12 is increased, and the reliability of positioning of the LGP 15 is increased.

The present invention is described in detail in accordance with the above contents with the specific preferred embodiments. However, this invention is not limited to the specific embodiments. For the ordinary technical personnel of the technical field of the present invention, on the premise of keeping the conception of the present invention, the technical personnel can also make simple deductions or replacements, and all of which should be considered to belong to the protection scope of the present invention.

We claim:

1. A backlight module, comprising: a light emitting diode (LED) light cluster composed of a group of LEDs, and a light guide plate (LGP) which is arranged on the LED side of the LED light cluster and is coupled with the LED, said backlight module also comprises one or more limit structures for making the position between the edge of said LGP and said LED light cluster be relatively fixed.

2. The backlight module of claim 1, wherein said limit structure is a projecting part which is fixed relatively to said LED and is extended to the LGP to limit the edge of the LGP.

3. The backlight module of claim 2, wherein said projecting part is of a wedge structure which is fixed relatively to the LED, and is arranged above or below said LED and protrudes above the emergent-light surface of the LED; and the beveled surface of the wedge structure faces the LGP.

4. The backlight module of claim 3, wherein the position of the LGP corresponding to the wedge structure is provided with a chamfer structure corresponding to the beveled surface of said wedge structure.

5. The backlight module of claim 2, wherein each single LED of said LED light cluster is externally provided with independent packaging, and said limit structure is arranged on the independent packaging of the single LED of said LED light cluster.

6. The backlight module of claim 2, wherein all the LEDs of said LED light cluster are externally provided with integral packaging, and said limit structure is arranged on the integral packaging of said LED light cluster.

7. The backlight module of claim 2, wherein said limit structure is arranged on the printed circuit board (PCB) fixed relatively to said LED light cluster.

8. The backlight module of claim 1, wherein said limit structure is a projecting part which is fixed relatively to the edge of the LGP and is extended to the fixed structure of the LED to limit the LGP.

9. The backlight module of claim 1, wherein said limit structure is a lug boss which is fixed relatively to said LED light cluster or is arranged at the edge of said LGP; correspondingly, the edge of the LGP or the position fixed relatively to said LED light cluster is provided with a depression corresponding to said lug boss.

10. A liquid crystal display (LCD) device comprises the backlight module of claim 1; said backlight module comprises a LED light cluster composed of a group of LEDs, and a light guide plate which is arranged on the LED side of the LED light cluster and is coupled with the LEDs, said backlight module also comprises a limit structure for making the position between the edge of said LGP and said LED light cluster be relatively fixed.

11. The LCD device of claim 10, wherein said limit structure is a projecting part which is fixed relatively to said LED and is extended to the LGP to limit the edge of the LGP.

12. The LCD device of claim 11, wherein said projecting part is of a wedge structure which is fixed relatively to the LED, is arranged above or below said LED and protrudes above the emergent-light surface of the LED; and the beveled surface of the wedge structure faces the LGP.

13. The LCD device of claim 12, wherein the position of the LGP corresponding to the wedge structure is provided with a chamfer structure corresponding to the beveled surface of said wedge structure.

14. The LCD device of claim 11, wherein each single LED of said LED light cluster is externally provided with independent packaging, and said limit structure is arranged on the independent packaging of the single LED of said LED light cluster.

15. The LCD device of claim 11, wherein all the LEDs of said LED light cluster are externally provided with integral packaging, and said limit structure is arranged on the integral packaging of said LED light cluster.

16. The LCD device of claim 11, wherein said limit structure is arranged on the PCB fixed relatively to said LED light cluster.

17. The LCD device of claim 10, wherein said limit structure is a projecting part which is fixed relatively to the edge of the LGP and is extended to the fixed structure of the LED.

18. The LCD device of claim 10, wherein said limit structure is a lug boss which is fixed relatively to said LED light cluster or is arranged at the edge of said LGP; correspondingly, the edge of the LGP or the position fixed relatively to said LED light cluster is provided with a depression corresponding to said lug boss.
